(19) United States
(12) Patent Application Publication
(10) Pub. No.: US 2022/0091898 A1
(43) Pub. Date: Mar. 24, 2022

(54) DYNAMIC VOLUME POOLING IN DATA STORAGE MANAGEMENT

(71) Applicant: International Business Machines Corporation, Armonk, NY (US)

(72) Inventors: Ming Qiao Shang Guan, BEIJING (CN); Jing BJ Ren, BEIJING (CN); Mai Zeng, BEIJING (CN); Yu Mei Dai, BEIJING (CN); Xiao Chen Huang, BEIJING (CN)

(21) Appl. No.: 17/026,237

(22) Filed: Sep. 20, 2020

(51) Int. Cl. G06F 9/50; G06F 9/48

(52) U.S. Cl. CPC G06F 9/5077; G06F 9/4881; G06F 2209/503; G06F 2209/5011; G06F 9/505

(57) ABSTRACT

A job is received. The job indicates moving one or more data to a pool storage group (PSG). The job includes resource requirements and the resource requirements include a size requirement to store the one or more data and a volume requirement to store the one or more data. A resource availability of the PSG is received. The resource availability of the PSG includes an available space on the PSG and one or more available volume on the PSG. Whether the resource availability of the PSG meets the resource requirements of the job is determined. Whether the PSG has a dynamic pool storage group (DPSG) flag indication on is determined.

### BACKGROUND

The present invention relates generally to data storage management, and more particularly to dynamic volume pooling in data storage management.

Data storage is the recording of information (data) in a storage medium. Users rely on distributed storage systems to store information and data. As more and more data is consumed with the increased use of computing devices more and more information and data must be stored in storage mediums. Each storage medium offers price vs. performance characteristics that, when applied properly, can provide optimal price for storing data with optimal performance for accessing the data.

### SUMMARY

Embodiments of the present invention include a computer-implemented method, computer program product, and computer system for volume allocation in dynamic volume pooling. In one embodiment, a job is received. The job indicates moving one or more data to a pool storage group (PSG). The job includes resource requirements and the resource requirements include a size requirement to store the one or more data and a volume requirement to store the one or more data. A resource availability of the PSG is received. The resource availability of the PSG includes an available space on the PSG and one or more available volume on the PSG. Whether the resource availability of the PSG meets the resource requirements of the job is determined. Whether the PSG has a dynamic pool storage group (DPSG) flag indication on is determined.

### BRIEF DESCRIPTION OF THE DRAWINGS

FIG. 1 is a functional block diagram of a network computing environment, generally designated 100, suitable for operation of dynamic volume pooling (DVP) program 112 in accordance with at least one embodiment of the invention.

FIG. 2 is a flow chart diagram depicting operational steps for DVP program 112 for volume allocation in dynamic volume pooling, in accordance with a first embodiment of the invention.

FIG. 3 is a flow chart diagram depicting operational steps for DVP program 112 for volume recycle in dynamic volume pooling, in accordance with a first embodiment of the invention.

FIG. 4 is an example PSG Map configuration file, in accordance with a first embodiment of the invention.

FIG. 5 is a block diagram depicting components of a computer, generally designated 500, suitable for executing DVP program 112, in accordance with at least one embodiment of the invention.

### DETAILED DESCRIPTION

Storage management systems store large amount of data in multiple volumes of the storage solution. A few problems can occur when storing data. First, there may not be enough space in any volume for a allocation requirement of a data transfer job. Second, there may not be enough available volumes for a volume requirement of a data transfer job. In either of these scenarios, the data transfer job will fail causing wasted time and resources.

Embodiments of the present invention provide at least for a program to allocate a dynamic volume pooling to reduce the number of failed data transfer jobs. Embodiments of the present invention provide at least for a program to perform dynamic volume pooling to recycle the dynamic volume pool and use the originally intended storage for the data transfer job.

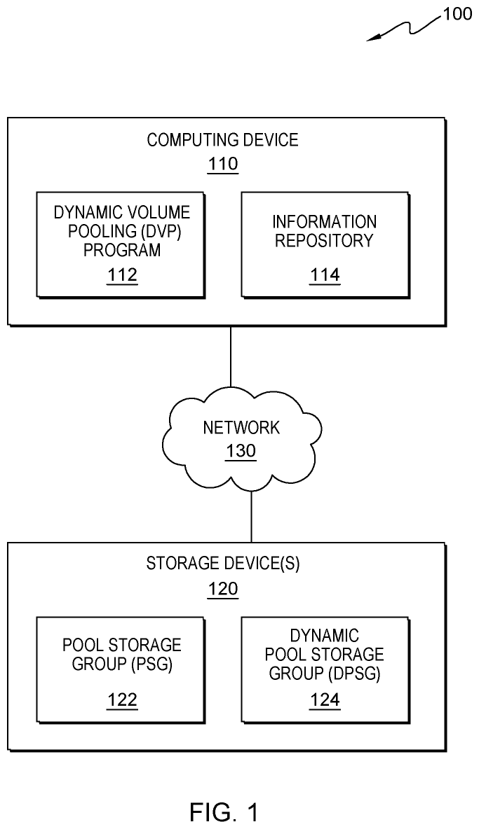

Referring now to various embodiments of the invention in more detail, FIG. 1 is a functional block diagram of a network computing environment, generally designated 100, suitable for operation of dynamic volume pooling (DVP) program 112 in accordance with at least one embodiment of the invention. FIG. 1 provides only an illustration of one implementation and does not imply any limitation with regard to the environments in which different embodiments may be implemented. Many modifications to the depicted environment may be made by those skilled in the art without departing from the scope of the invention as recited by the claims.

Network computing environment 100 includes computing device 110 and storage device(s) 120 interconnected over network 130. In embodiments of the present invention, network 130 can be a telecommunications network, a local area network (LAN), a wide area network (WAN), such as the Internet, or a combination of the three, and can include wired, wireless, or fiber optic connections. Network 130 may include one or more wired and/or wireless networks that are capable of receiving and transmitting data, voice, and/or video signals, including multimedia signals that include voice, data, and video formation. In general, network 130 may be any combination of connections and protocols that will support communications between computing device 110, storage device(s) 120, and other computing devices (not shown) within network computing environment 100.

Computing device 110 is a computing device that can be a laptop computer, tablet computer, netbook computer, personal computer (PC), a desktop computer, a personal digital assistant (PDA), a smartphone, smartwatch, or any programmable electronic device capable of receiving, sending, and processing data. In general, computing device 110 represents any programmable electronic devices or combination of programmable electronic devices capable of executing machine readable program instructions and communicating with other computing devices (not shown) within computing environment 100 via a network, such as network 130.

In various embodiments of the invention, computing device 110 may be a computing device that can be a standalone device, a management server, a web server, a media server, a mobile computing device, or any other programmable electronic device or computing system capable of receiving, sending, and processing data. In other embodiments, computing device 110 represents a server computing system utilizing multiple computers as a server system, such as in a cloud computing environment. In an embodiment, computing device 110 represents a computing system utilizing clustered computers and components (e.g. database server computers, application server computers, web servers, and media servers) that act as a single pool of seamless resources when accessed within network computing environment 100.

In various embodiments of the invention, computing device 110 includes DVP program 112 and information repository 114.

In an embodiment, computing device 110 includes DVP program 112. Embodiments of the present invention provide for a DVP program 112 that receives a job. In embodiments of the present invention, DVP program 112 check volume(s) in PSG. In embodiments of the present invention, DVP program 112 determines whether PSG volume(s) meet requirements of the job. In embodiments of the present invention, DVP program 112 returns PSG volume(s). In embodiments of the present invention, DVP program 112 determines if a DPSG flag is on. In embodiments of the present invention, DVP program 112 check volume(s) in DPSG. In embodiments of the present invention, DVP program 112 determines whether DPSG volume(s) meet requirements. In embodiments of the present invention, DVP program 112 indicates a failure. In embodiments of the present invention, DVP program 112 updates the PSG map. In embodiments of the present invention, DVP program 112 returns DPSG volume.

Embodiments of present invention provide for a DVP program 112 that monitors PSG. In embodiments of the present invention, DVP program 112 monitors the PSG map. In embodiments of the present invention, DVP program 112 determines whether PSG volume(s) meet requirements. In embodiments of the present invention, DVP program 112 check DPSG volume(s). In embodiments of the present invention, DVP program 112 selects volume(s). In embodiments of the present invention, DVP program 112 copy data volume(s) from DPSG to PSG. In embodiments of the present invention, DVP program 112 determines whether the copy was successful. In embodiments of the present invention, DVP program 112 updates PSG map.

In an embodiment, computing device 110 includes information repository 114. In an embodiment, information repository 114 may be managed by DVP program 112. In an alternative embodiment, information repository 114 may be managed by the operating system of computing device 110, another program in network computing environment 100, another program (not shown), alone, or together with, DVP program 112. Information repository 114 is a data repository that can store, gather, and/or analyze information. In some embodiments, information repository 114 is located externally to computing device 110 and accessed through a communication network, such as network 130. In some embodiments, information repository 114 is stored on computing device 110. In some embodiments, information repository 114 may reside on another computing device (not shown), provided information repository 114 is accessible by computing device 110. Information repository 114 may include, but is not limited to, SG map, time threshold, free space threshold, scheduling information, etc.

Information repository 114 may be implemented using any volatile or non-volatile storage media for storing information, as known in the art. For example, information repository 114 may be implemented with a tape library, optical library, one or more independent hard disk drives, multiple hard disk drives in a redundant array of independent disks (RAID), solid-state drives (SSD), or random-access memory (RAM). Similarly, information repository 114 may be implemented with any suitable storage architecture known in the art, such as a relational database, an object-oriented database, or one or more tables.

Storage device(s) 120 is one or more computing devices that can be a laptop computer, tablet computer, netbook computer, personal computer (PC), a desktop computer, a personal digital assistant (PDA), a smartphone, smartwatch, or any programmable electronic device capable of receiving, sending, and processing data. In general, storage device(s) 120 represents any programmable electronic devices or combination of programmable electronic devices capable of executing machine readable program instructions and communicating with other computing devices (not shown) within computing environment 100 via a network, such as network 130.

In various embodiments of the invention, storage device(s) 120 may be a computing device that can be a standalone device, a management server, a web server, a media server, a mobile computing device, or any other programmable electronic device or computing system capable of receiving, sending, and processing data. In other embodiments, storage device(s) 120 represents a server computing system utilizing multiple computers as a server system, such as in a cloud computing environment. In an embodiment, storage device(s) 120 represents a computing system utilizing clustered computers and components (e.g. database server computers, application server computers, web servers, and media servers) that act as a single pool of seamless resources when accessed within network computing environment 100.

In various embodiments of the invention, storage device(s) 120 includes pool storage group (PSG) 122 and dynamic pool storage group (DPSG) 124.

In an embodiment, storage device(s) 120 includes PSG 122. In an embodiment, PSG 122 may be managed by DVP program 112. In an alternative embodiment, PSG 122 may be managed by the operating system of storage device(s) 120, another program in network computing environment 100, another program (not shown), alone, or together with, DVP program 112. PSG 122 is a data repository that can store, gather, and/or analyze information. In some embodiments, PSG 122 is located externally to storage device(s) 120 and accessed through a communication network, such as network 130. In some embodiments, PSG 122 is stored on storage device(s) 120. In some embodiments, PSG 122 may reside on another computing device (not shown), provided PSG 122 is accessible by storage device(s) 120. PSG 122 may include, but is not limited to, data. In an embodiment, there may be any number of PSG 122 of any size and any number of logical volumes or simply “volumes”.

PSG 122 may be implemented using any volatile or non-volatile storage media for storing information, as known in the art. For example, PSG 122 may be implemented with a tape library, optical library, one or more independent hard disk drives, multiple hard disk drives in a redundant array of independent disks (RAID), solid-state drives (SSD), or random-access memory (RAM). Similarly, PSG 122 may be implemented with any suitable storage architecture known in the art, such as a relational database, an object-oriented database, or one or more tables.

In an embodiment, storage device(s) 120 includes DPSG 124. In an embodiment, DPSG 124 may be managed by DVP program 112. In an alternative embodiment DPSG 124 may be managed by the operating system of storage device(s) 120, another program in network computing environment 100, another program (not shown), alone, or together with, DVP program 112. DPSG 124 is a data repository that can store, gather, and/or analyze information. In some embodiments, DPSG 124 is located externally to storage device(s) 120 and accessed through a communication network, such as network 130. In some embodiments, DPSG 124 is stored on storage device(s) 120. In some embodiments, DPSG 124 may reside on another computing device (not shown), provided DPSG 124 is accessible by storage device(s) 120. DPSG 124 may include, but is not limited to, data. In an embodiment, there may be any number of DPSG 124 of any size and any number of logical volumes or simply “volumes”.

DPSG 124 may be implemented using any volatile or non-volatile storage media for storing information, as known in the art. For example, DPSG 124 may be implemented with a tape library, optical library, one or more independent hard disk drives, multiple hard disk drives in a redundant array of independent disks (RAID), solid-state drives (SSD), or random-access memory (RAM). Similarly, DPSG 124 may be implemented with any suitable storage architecture known in the art, such as a relational database, an object-oriented database, or one or more tables.

As referred to herein, all data retrieved, collected, and used, is used in an opt-in manner, i.e., the data provider has given permission for the data to be used. For example, the received data received and used by DVP program 112 for allocation and recycle.

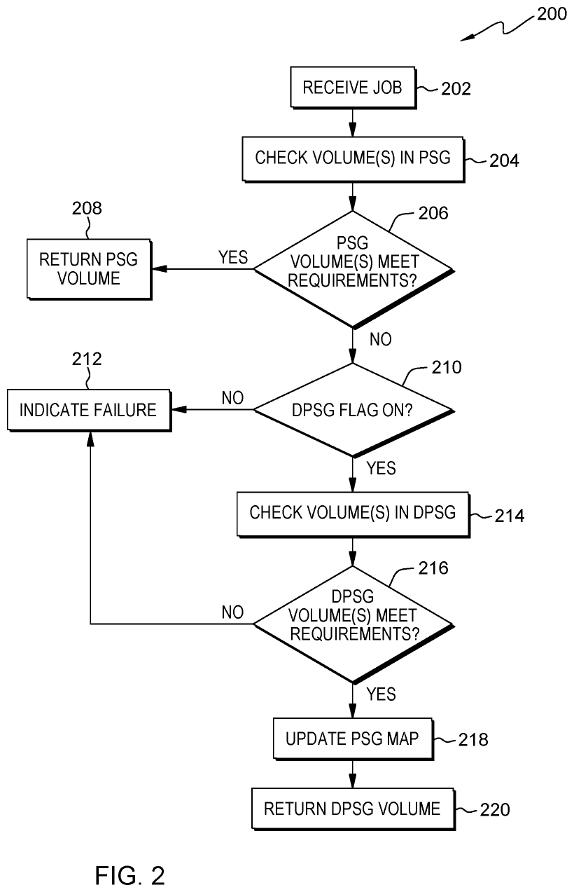

FIG. 2 is a flow chart diagram of workflow 200 depicting operational steps for DVP program 112 in accordance with at least one embodiment of the invention. In an alternative embodiment, the steps of workflow 200 may be performed by any other program while working with DVP program 112. It should be appreciated that embodiments of the present invention provide at least for currency conversion. However, FIG. 2 provides only an illustration of one implementation and does not imply any limitations with regard to the environments in which different embodiments may be implemented. Many modifications to the depicted environment may be made by those skilled in the art without departing from the scope of the invention as recited by the claims. In a preferred embodiment, a user, via a user interface (not shown), can invoke workflow 200 upon a user wanting DVP program 112 to complete a storage job.

DVP program 112 receives a job (step 202). At step 202, DVP program 112 receives an indication of a job to move data to PSG 122. In an embodiment, the job includes resource requirements, including, but not limited to, size requirements to store the data, and volume requirements to store the data, etc. In an embodiment, the job may arrive from a user via an indication on a user interface. In an alternative embodiment, the job may arrive from another program (not shown) that would like to move data to PSG 122.

DVP program 112 checks volume(s) in PSG 122 (step 204). At step 204, DVP program 112 checks the resource availability of the PSG 122 assigned to the job. In other words, DVP program 112 determines the requirements of the received job (i.e., specific PSG that the data of the job should be stored on based on service agreements, the indication from the user, etc.) and then DVP program 112 determines the resource availability, including but not limited to, available space to store data, available volumes to store data, etc. on PSG 122.

DVP program 112 determines whether PSG volume(s) meet requirements (decision step 206). At decision step 206, DVP program 112 determines whether the resource requirements of the job received in step 202 are met by the resource availability determinized during the volume(s) check of step 204. In an embodiment, only one of the resource requirements need to be met. In an alternative embodiment, all of the resource requirements need to be met. Responsive to determining that the PSG 122 volume(s) meet the requirements (decision step 206, yes branch) processing proceeds to step 208. Responsive to determining that the PSG 122 volume(s) do not meet the requirements (decision step 206, no branch) processing proceeds to step 210.

DVP program 112 returns the PSG volume (step 208). At step 208, DVP program 112 indicates the PSG 122 volume(s) that will be used to process the job received in step 202. In an embodiment, DVP program 112 processes the data transfer and stores the data of the received job in the indicated PSG 122 volume(s). In an embodiment, DVP program 112 indicates to another program (not shown) that will process the data transfer and store the data of the received job in the indicated PSG 122 volume(s). In an embodiment, DVP program 112 may indicate more than one volume that can process the data transfer and another program (not shown) that manages PSG 122 will determine the proper volume(s) to store the data.

DVP program 112 determines whether there is a DPSG flag on (decision step 210). At step 210, DVP program 112 determines whether the PSG 122 assigned to the job has a DPSG flag. In an embodiment, information repository 114 stores information regarding PSG, such as PSG 122, and whether the PSG has a DPSG flag turned on or off. In an embodiment, if the DPSG flag is turned on for PSG 122 then DPSG 124 may be used to store data that PSG 122 cannot handle due to resource requirements. In an embodiment, if the DPSG flag is turned off for PSG 122 then DPSG 124 may not be used to store data that PSG 122 cannot handle due to resource requirements. Responsive to determining that the PSG flag is turned on (decision step 210, yes branch) processing proceeds to step 214. Responsive to determining that the PSG flag is not turned on (decision step 210, no branch) processing proceeds to step 212.

DVP program 112 indicates failure (step 212). At step 212, DVP program 112 indicates that the job received in step 202 was not able to be processed and therefore the job failed. In an embodiment, a notification may be displayed on the user interface of computing device 110. In an alternative embodiment, DVP program 112 may indicate to another program (not shown) that requested the job that the processing of the job ended in a failure and the other program (not shown) may indicate a failure of the job.

DVP program 112 checks volume(s) in DPSG (step 214). At step 214, DVP program 112 checks the resource availability of the DPSG 124 assigned to the PSG 122 with a flag on indication. In other words, DVP program 112 determines the requirements of the received job (i.e., specific PSG that the data of the job should be stored on) and then DVP program 112 determines the resource availability, including but not limited to, available space to store data, available volumes to store data, etc. on DPSG 124.

DVP program 112 determines whether DPSG volume(s) meet requirements (decision step 216). At decision step 206, DVP program 112 determines whether the resource requirements of the job received in step 202 are met by the resource availability determinized during the check volume(s) in DPSG 124 of step 214. In an embodiment, only one of the resource requirements need to be met. In an alternative embodiment, all of the resource requirements need to be met. Responsive to determining that the DPSG 124 volume(s) meet the requirements (decision step 216, yes branch) processing proceeds to step 218. Responsive to determining that the 124 DPSG volume(s) do not meet the requirements (decision step 216, no branch) processing proceeds to step 212.

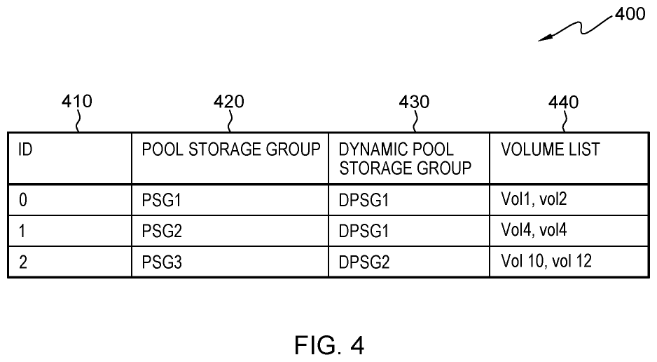

DVP program 112 updates PSG map (step 218). At step 218, DVP program 112 updates PSG map, found in information repository 114. In other words, DVP program 112 indicates in the PSG map in information repository 114 the DPSG 124 volume(s) used to store the data for processing the job received in step 202 and the PSG 122 volume(s) associated. An example PSG map shown in FIG. 4 will be discussed below.

DVP program 112 returns the DPSG volume (step 220). At step 220, DVP program 112 indicates the DPSG 124 volume(s) that will be used to process the job received in step 202. In an embodiment, DVP program 112 processes the data transfer and stores the data of the received job in the indicated DPSG 124 volume(s). In an embodiment, DVP program 112 indicates to another program (not shown) that will process the data transfer and store the data of the received job in the indicated DPSG 124 volume(s). In an embodiment, DVP program 112 may indicate more than one volume that can process the data transfer and another program (not shown) that manages DPSG 124 will determine the proper volume(s) to store the data.

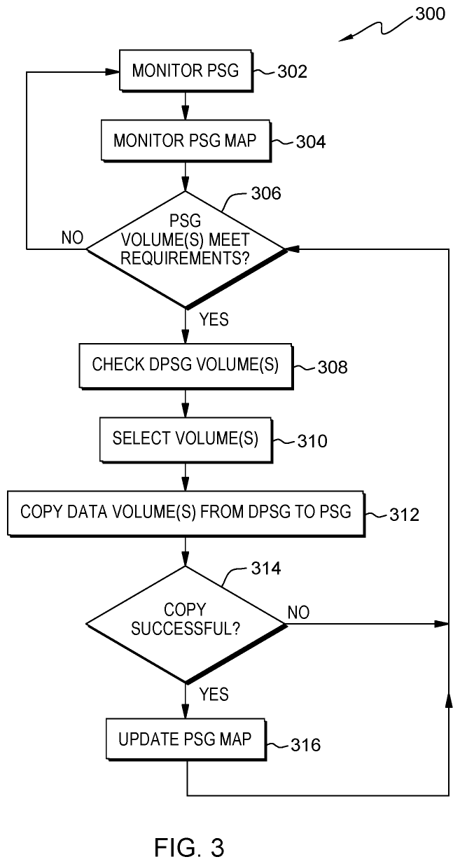

FIG. 3 is a flow chart diagram of workflow 300 depicting operational steps for DVP program 112 in accordance with at least one embodiment of the invention. In an alternative embodiment, the steps of workflow 300 may be performed by any other program while working with DVP program 112. It should be appreciated that embodiments of the present invention provide at least for currency conversion. However, FIG. 3 provides only an illustration of one implementation and does not imply any limitations with regard to the environments in which different embodiments may be implemented. Many modifications to the depicted environment may be made by those skilled in the art without departing from the scope of the invention as recited by the claims. In an embodiment, a user, via a user interface (not shown), or a trigger can invoke workflow 300 upon wanting DVP program 112 complete a storage recycle. In an embodiment, the trigger may be a schedule, for example workflow 300 operate during a specific time frame (i.e. 2:00 AM to 6:00 AM) or every time period (i.e. every three hours). In an embodiment, the trigger may be when DVP program 112 receives an indication that PSG 122 has a threshold amount of free space (i.e. 50% free space).

DVP program 112 monitors PSG (step 302). At step 302, DVP program 112 checks the resource availability of PSG 122. In other words, DVP program 112 determines the resource availability, including but not limited to, available space to store data, available volumes to store data, etc. on PSG 122.

DVP program 112 monitors PSG map (step 304). At step 304, DVP program 112 monitors PSG map to determine the DPSG 124 that are used for additional storage by PSG 122. In an embodiment, DVP program 112 monitors the resource requirements of the data jobs stored in DPSG 124.

DVP program 112 determines whether PSG volume(s) meet requirements (decision step 306). At decision step 306, DVP program 112 determines whether the resource requirements of the data jobs stored in DPSG 124 are met by the resource availability determinized during the monitor PSG of step 302. In an embodiment, only one of the resource requirements need to be met. In an alternative embodiment, all of the resource requirements need to be met. Responsive to determining that the PSG 122 volume(s) meet the requirements (decision step 306, yes branch) processing proceeds to step 208. Responsive to determining that the PSG 122 volume(s) do not meet the requirements (decision step 306, no branch) processing proceeds to step 302.

DVP program 112 checks DPSG Volume(s) (step 308). At step 208, DVP program 112 checks DPSG 124 volume(s) to determine which data jobs stored in DPSG 124 can be moved to PSG 122 based on the determined resource availability of the PSG 122 volume(s). In an embodiment, there may be one or more data jobs that can be moved based on the determined resource availability.

DVP program 112 selects volume(s) (step 310). At step 210, DVP program 112 selects which data job stored in volume(s) on DPSG 124 to move to PSG 122. In an embodiment, a only a single data job may be moved based on the resource availability on PSG 122. In an alternative embodiment, multiple data jobs may be moved based on the resource availability on PSG 122. Here, DVP program 112 may provide an indication to a user, via a user interface, to choose which data jobs to move from DPSG 124 to PSG 122. In an embodiment, DVP program 112 may use algorithms known in the art such as first-in first-out, last-in first-out, or DVP program 112 may custom priority lists input by a user and stored information repository 114.

DVP program 112 copies data volume(s) from DPSG to PSG (step 312). At step 312, DVP program 112 copies the selected volume(s) from DPSG 124 to PSG 122. In an embodiment, DVP Program 112 copies the data jobs using DSS logical or flash copy. In an embodiment, a journal dataset, stored in information repository 114, may record the status of each copy job. In an embodiment, DVP program 112 may indicate to another program, not shown, to copy the determined data volume(s).

DVP program 112 determines whether the copy is successful (decision step 314). In an embodiment, DVP program 112 may monitor PSG 122 to determine if the data job was moved to PSG 122. In an alternative embodiment, DVP program 112 may monitor the journal dataset in information repository 114 to determine if the data job was moved to PSG 122. Responsive to determining that the copy was successful (decision step 314, yes branch) processing proceeds to step 316. Responsive to determining that the copy was not successful (decision step 306, no branch) processing proceeds to step 306.

DVP program 112 updates PSG map (step 316). At step 316, DVP program 112 updates PSG map, found in information repository 114. In other words, DVP program 112 indicates in the PSG map in information repository 114 that the copy was successful and therefore removes the data job from the PSG map. An example PSG map shown in FIG. 4 will be discussed below.

FIG. 4 is an example PSG map configuration file 400 depicting the PSG 122, DPSG 124, and related volume(s). In an embodiment, the PSG map configuration file 400 includes an ID column 410 also known as an “entry” used to organize allocations. In an embodiment, the PSG map configuration file 400 includes a Pool Storage Group column 420 indicating the PSG 122 allocated to the DPSG 124. In an embodiment, the PSG map configuration file 400 includes a Dynamic Pool Storage Group column 430 indicating the DPSG 124 allocated to the PSG 122. In an embodiment, the PSG map configuration file 400 includes a volume list column 440 indicate the volumes of DPSG 124 allocated to the PSG 122. In an embodiment, the PSG 122 can only have one related DPSG 124. In an embodiment, the DPSG 124 may be assigned to multiple PSG 122. In an embodiment, volume(s) in DPSG 124 may be allocated to a PSG 122 meaning the volume(s) in the volume column are exclusive in each entry. In an embodiment, when a DPSG 124 is used for a data transfer job to a PSG 122, a new entry is added to the PSG map configuration file, as shown in step 218. When all volumes in the volume list are recycled in an entry, the entry is removed, as shown in step 316.

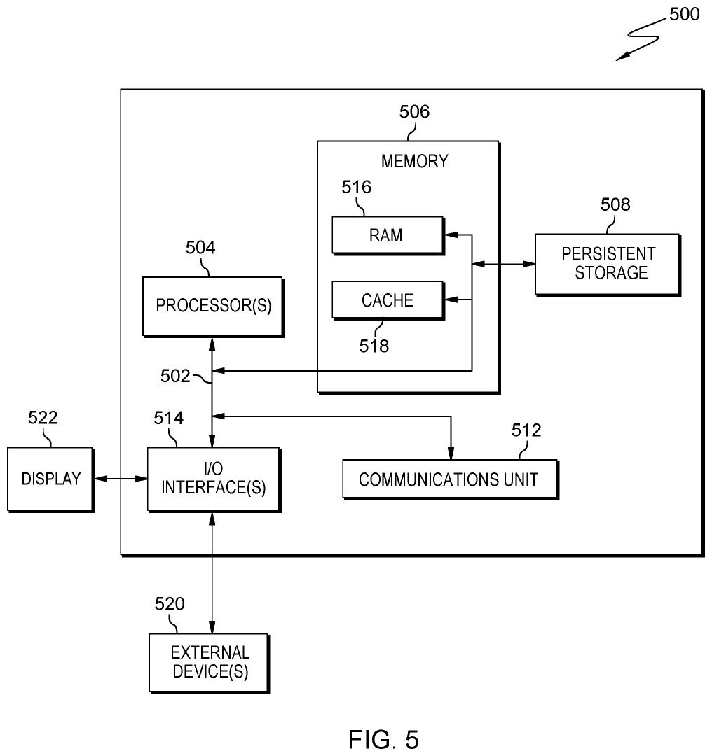

FIG. 5 is a block diagram depicting components of a computer 500 suitable for DVP program 112, in accordance with at least one embodiment of the invention. FIG. 5 displays the computer 500, one or more processor(s) 504 (including one or more computer processors), a communications fabric 502, a memory 506 including, a RAM 516, and a cache 518, a persistent storage 508, a communications unit 512, I/O interfaces 514, a display 522, and external devices 520. It should be appreciated that FIG. 5 provides only an illustration of one embodiment and does not imply any limitations with regard to the environments in which different embodiments may be implemented. Many modifications to the depicted environment may be made.

As depicted, the computer 500 operates over the communications fabric 502, which provides communications between the computer processor(s) 504, memory 506, persistent storage 508, communications unit 512, and input/output (I/O) interface(s) 514. The communications fabric 502 may be implemented with an architecture suitable for passing data or control information between the processors 504 (e.g., microprocessors, communications processors, and network processors), the memory 506, the external devices 520, and any other hardware components within a system. For example, the communications fabric 502 may be implemented with one or more buses.

The memory 506 and persistent storage 508 are computer readable storage media. In the depicted embodiment, the memory 506 comprises a random-access memory (RAM) 516 and a cache 518. In general, the memory 506 may comprise any suitable volatile or non-volatile one or more computer readable storage media.

Program instructions for DVP program 112 may be stored in the persistent storage 508, or more generally, any computer readable storage media, for execution by one or more of the respective computer processors 504 via one or more memories of the memory 506. The persistent storage 508 may be a magnetic hard disk drive, a solid-state disk drive, a semiconductor storage device, read only memory (ROM), electronically erasable programmable read-only memory (EEPROM), flash memory, or any other computer readable storage media that is capable of storing program instruction or digital information.

The media used by the persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of the persistent storage 508.

The communications unit 512, in these examples, provides for communications with other data processing systems or devices. In these examples, the communications unit 512 may comprise one or more network interface cards. The communications unit 512 may provide communications through the use of either or both physical and wireless communications links. In the context of some embodiments of the present invention, the source of the various input data may be physically remote to the computer 500 such that the input data may be received, and the output similarly transmitted via the communications unit 512.

The I/O interface(s) 514 allow for input and output of data with other devices that may operate in conjunction with the computer 500. For example, the I/O interface 514 may provide a connection to the external devices 520, which may be as a keyboard, keypad, a touch screen, or other suitable input devices. External devices 520 may also include portable computer readable storage media, for example thumb drives, portable optical or magnetic disks, and memory cards. Software and data used to practice embodiments of the present invention may be stored on such portable computer readable storage media and may be loaded onto the persistent storage 508 via the I/O interface(s) 514. The I/O interface(s) 414 may similarly connect to a display 5422. The display 522 provides a mechanism to display data to a user and may be, for example, a computer monitor.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disk read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adaptor card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, though the Internet using an Internet Service Provider). In some embodiments, electronic circuitry including, for example programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram blocks or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of computer program instructions, which comprises one or more executable instructions for implementing the specified logical function(s). In some alternative implementations, the functions noted in the block may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing form the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for volume allocation in dynamic volume pooling, the computer-implemented method comprising:
receiving, by one or more computer processors, a job, wherein the job indicates moving one or more data to a pool storage group (PSG), and further wherein the job includes resource requirements, and wherein the resource requirements include a size requirement to store the one or more data and a volume requirement to store the one or more data;
receiving, by one or more computer processors, a resource availably of the PSG, wherein the resource availability of the PSG includes an available space on the PSG and one or more available volume on the PSG;
determining, by one or more computer processors, whether the resource availability of the PSG meets the resource requirements of the job; and
responsive to determining the resource availably of the PSG does not meet the resource requirements of the job, determining, by one or more computer processors, whether the PSG has a dynamic pool storage group (DPSG) flag indication on.

2. The computer-implemented method of claim 1, further comprising:
responsive to determining the PSG does not have a DPSG flag indication on, indicating, by one or more computer processors, a failure of the job.

3. The computer-implemented method of claim 1, further comprising:
responsive to determining the PSG does not have a DPSG flag indication on, receiving, by one or more computer processors, a resource availably of the DPSG, wherein the resource availability of the DPSG includes an available space on the DPSG and one or more available volumes on the DPSG;
determining, by one or more computer processors, whether the resource availability of the DPSG meets the resource requirements of the job.

4. The computer-implemented method of claim 3, further comprising:
responsive to determining the resource availably of the DPSG does not meet the resource requirements of the job, indicating, by one or more computer processors, a failure of the job.

5. The computer-implemented method of claim 3, further comprising:
responsive to determining the resource availably of the DPSG does meet the resource requirements of the job, indicating, by one or more computer processors, to use the DPSG to perform the job; and
updating, by one or more computer processors, a PSG map, wherein the PSG map includes the PSG, the DPSG associated with the PSG, and volumes being used on the DPSG.

6. The computer-implemented method of claim method of claim 5, further comprising:
determining, by one or more computer processors, whether the resource of the PSG meets a resource requirements of one or more jobs stored in the DPSG; and
responsive to determining the PSG meets the resource requirements of a second job of the one or more jobs stored in the DPSG, indicating, by one or more computer processors, to copy the second job to the PSG and remove the second job from the DPSG.

7. The computer-implemented method of claim method of claim 6, further comprising:
updating, by one or more computer processors, the PSG map to indicate the removal of the second job from the DPSG.

8. A computer program product for volume allocation in dynamic volume pooling, the computer program product comprising:
one or more computer readable storage media; and
program instructions stored on the one or more computer readable storage media, the program instructions comprising:
program instructions to receive a job, wherein the job indicates moving one or more data to a pool storage group (PSG), and further wherein the job includes resource requirements, and wherein the resource requirements include a size requirement to store the one or more data and a volume requirement to store the one or more data;
program instructions to receive a resource availably of the PSG, wherein the resource availability of the PSG includes an available space on the PSG and one or more available volume on the PSG;
program instructions to determine whether the resource availability of the PSG meets the resource requirements of the job; and
program instructions, responsive to determining the resource availably of the PSG does not meet the resource requirements of the job, to determine whether the PSG has a dynamic pool storage group (DPSG) flag indication on.

9. The computer program product of claim 8, further comprising program instructions, stored on the one or more computer readable storage media, to:
responsive to determining the PSG does not have a DPSG flag indication on, indicate a failure of the job.

10. The computer program product of claim 8, further comprising program instructions, stored on the one or more computer readable storage media, to:
responsive to determining the PSG does not have a DPSG flag indication on, receive a resource availably of the DPSG, wherein the resource availability of the DPSG includes an available space on the DPSG and one or more available volumes on the DPSG;
determine whether the resource availability of the DPSG meets the resource requirements of the job.

11. The computer program product of claim 10, further comprising program instructions, stored on the one or more computer readable storage media, to:
responsive to determining the resource availably of the DPSG does not meet the resource requirements of the job, indicate a failure of the job.

12. The computer program product of claim 10, further comprising program instructions, stored on the one or more computer readable storage media, to:
responsive to determining the resource availably of the DPSG does meet the resource requirements of the job, indicate to use the DPSG to perform the job; and
update a PSG map, wherein the PSG map includes the PSG, the DPSG associated with the PSG, and volumes being used on the DPSG.

13. The computer program product of claim 12, further comprising program instructions, stored on the one or more computer readable storage media, to:
determine whether the resource of the PSG meets a resource requirements of one or more jobs stored in the DPSG; and
responsive to determining the PSG meets the resource requirements of a second job of the one or more jobs stored in the DPSG, indicate to copy the second job to the PSG and remove the second job from the DPSG.

14. The computer program product of claim 13, further comprising program instructions, stored on the one or more computer readable storage media, to:
update the PSG map to indicate the removal of the second job from the DPSG.

15. A computer system for volume allocation in dynamic volume pooling, the computer system comprising:
one or more computer processors;
one or more computer readable storage media; and
program instructions, stored on the one or more computer readable storage media for execution by at least one of the one or more computer processors, the program instructions comprising;
program instructions to receive a job, wherein the job indicates moving one or more data to a pool storage group (PSG), and further wherein the job includes resource requirements, and wherein the resource requirements include a size requirement to store the one or more data and a volume requirement to store the one or more data;
program instructions to receive a resource availably of the PSG, wherein the resource availability of the PSG includes an available space on the PSG and one or more available volume on the PSG;
program instructions to determine whether the resource availability of the PSG meets the resource requirements of the job; and
program instructions, responsive to determining the resource availably of the PSG does not meet the resource requirements of the job, to determine whether the PSG has a dynamic pool storage group (DPSG) flag indication on.

16. The computer system of claim 15, further comprising program instructions, stored on the one or more computer readable storage media for execution by the at least one of the one or more computer processors, to:
responsive to determining the PSG does not have a DPSG flag indication on, indicate a failure of the job.

17. The computer system of claim 15, further comprising program instructions, stored on the one or more computer readable storage media for execution by the at least one of the one or more computer processors, to:
responsive to determining the PSG does not have a DPSG flag indication on, receive a resource availably of the DPSG, wherein the resource availability of the DPSG includes an available space on the DPSG and one or more available volumes on the DPSG;
determine whether the resource availability of the DPSG meets the resource requirements of the job.

18. The computer system of claim 17, further comprising program instructions, stored on the one or more computer readable storage media for execution by the at least one of the one or more computer processors, to:
responsive to determining the resource availably of the DPSG does not meet the resource requirements of the job, indicate a failure of the job.

19. The computer system of claim 17, further comprising program instructions, stored on the one or more computer readable storage media for execution by the at least one of the one or more computer processors, to:
responsive to determining the resource availably of the DPSG does meet the resource requirements of the job, indicate to use the DPSG to perform the job; and
update a PSG map, wherein the PSG map includes the PSG, the DPSG associated with the PSG, and volumes being used on the DPSG.

20. The computer system of claim 19, further comprising program instructions, stored on the one or more computer readable storage media for execution by the at least one of the one or more computer processors, to:
determine whether the resource of the PSG meets a resource requirements of one or more jobs stored in the DPSG; and
responsive to determining the PSG meets the resource requirements of a second job of the one or more jobs stored in the DPSG, indicate to copy the second job to the PSG and remove the second job from the DPSG.
